(19) United States
(12) Patent Application Publication
(10) Pub. No.: US 2012/0293470 A1
(43) Pub. Date: Nov. 22, 2012

(54) IMAGE DISPLAY DEVICE

(76) Inventor: Hideki Nakata, Osaka (JP)

(21) Appl. No.: 13/576,138

(22) PCT Filed: Feb. 23, 2011
(86) PCT No.: PCT/JP2011/001004

§ 371 Date: Jul. 30, 2012

(30) Foreign Application Priority Data
Feb. 23, 2010 (JP) 2010-036791

(51) Int. Cl. G09G 5/00

(52) U.S. Cl. 345/204

(57) ABSTRACT

An image display apparatus comprising a display device, a circuit board including first and second connectors each disposed at one of the two surfaces thereof, and a flexible circuit board connecting the display device and the circuit board. The flexible circuit board includes: a common circuit part and first and second circuit parts extending from one side of the common circuit part separately from each other; first and second wires respectively extending from the first and second circuit parts and meeting side-by-side at the common circuit part; device connection terminals disposed at the common circuit part; and first and second circuit connection terminals respectively disposed at the first and second circuit parts. The first and second circuit connection terminals are respectively connected with the first and second connectors while the flexible circuit board is folded at at least one of the first and second circuit parts.

### TECHNICAL FIELD

The present invention relates to an image display apparatus utilizing a flat panel type image display device, and in particular, to a technology for a flexible circuit board for connecting the image display device and a circuit board.

### DESCRIPTION OF THE RELATED ART

Conventionally, a flat panel type image display device (a so-called flat panel display (FPD)), typical examples of which include a plasma display panel (PDP) and a liquid crystal display (LCD), includes a substrate composed of glass or the like. On a surface of the substrate, a plurality of electrodes are formed so as to extend in both the row direction and the column direction. Further, at positions corresponding to intersections between the electrodes or other positions, a plurality of pixels are arranged so as to from a matrix.

Such an image display device is utilized in an image display apparatus by being electrically connected to a driving circuit board by utilizing flexible circuit boards (i.e., flexible printed circuits). When such an image display apparatus is driven, voltage is applied to the respective electrodes of the image display device. In specific, the application of voltage to the electrodes of the image display device is performed by the driving circuit board via the flexible circuit boards and in accordance with predetermined driving voltage waveforms. As such, displaying of images by the image display apparatus is realized.

Among such image display devices, a PDP having a typical structure includes a front substrate and a back substrate, which are arranged so as to face each other with a discharge space enclosed therebetween. The front substrate has a plurality of display electrode pairs (each composed of a scan electrode and a sustain electrode) formed thereon in an elongated state, and the back substrate has a plurality of data (address) electrodes formed thereon in an elongated state. Further, the front substrate and the back substrate are arranged with respect to each other such that the display electrode pairs and the data electrodes cross each other so as to form a matrix. In addition, a PDP commonly has a rectangular display surface. Electrode terminals are provided to a rectangular display surface of a PDP such that (i) electrode terminals corresponding to the data electrodes are provided along edge portions of the two long sides of the rectangular display surface, (ii) electrode terminals corresponding to the scan electrodes are provided along an edge portion of one short side of the rectangular display surface, and (iii) electrode terminals corresponding to the sustain electrodes are provided along an edge portion of the other short side of the rectangular display surface. In addition, flexible circuit boards are attached to such electrode terminals (refer to Patent Literature 1, for example). In further regards to the electrode terminals provided to a PDP, the number of the electrode terminals corresponding to the scan electrodes equals the number of pixels aligned in the column direction.

### CITATION LIST

### Patent Literature

### Patent Literature 1

Japanese Patent Application Publication No. 2004-086134

### SUMMARY OF INVENTION

### Technical Problem

Recently, FPDs such as a PDP are being provided with display surfaces having higher definition and larger sizes. Due to this, in a PDP for example, the display electrodes, which are disposed to form a matrix as explained above, are formed so as to have microscopic sizes for realizing high definition. Due to this, the electrode terminals corresponding to the display electrodes, which are to be connected with flexible circuit boards as explained above, are also formed so as to have microscopic sizes for realizing high definition.

On the other hand, a circuit board having a driving circuit for generating predetermined driving voltage waveforms, which are to be applied to the electrode terminals of a PDP, mounted thereon is required to meet predetermined safety standards. This is since there is a risk of problems such as dielectric breakdowns occurring (i) if the interval between the wires provided to the circuit board is shorter than required or (ii) if the pitch between electrode terminals provided to the circuit board is smaller than required. As such, even when connecting a high definition PDP with a driving circuit board to form an image display apparatus, the pitch between the electrode terminals of the driving circuit board cannot be simply reduced so as to be in accordance with the pitch between the microscopic electrode terminals of the PDP.

One possible countermeasure against such a problem would be to change the arrangement of connecters and wires provided to the circuit board having the driving circuit mounted thereon. However, it is extremely difficult to carry out countermeasures such as providing an increased number of wires to the circuit board and changing the arrangement of the connectors and wires provided to the circuit board so as to be in accordance with the microscopic electrode terminals of the PDP. Moreover, if such countermeasures as explained above are carried out, the arrangement of the circuit board itself in the image display apparatus may become difficult as a result.

In the meantime, there is a demand for downsized and spatially efficient image display apparatuses, and also, a demand for downsized circuit boards. However, due to an increase in the number of electrode terminals provided to an image display device, an increase is brought about in the number of connecters provided to a circuit board, which are to be electrically connected with the electrode terminals of the image display device. Hence, the downsizing of circuit boards cannot be realized with ease.

Further, when attempting to improve spatial efficiency of a circuit board by providing connecters in a dispersed state at various positions on the circuit board, the number of procedures required in assembling the image display apparatus increases. This is since, when such a circuit board having connectors provided thereto in a dispersed state is connected with flexible circuit boards, the flexible circuit boards would cross each other above the circuit board. In the mean time, when flexible circuit boards having different shapes are utilized to connect a circuit board with an image display device, the flexible circuit boards exhibit varying impedance characteristics and further, the increased impedance values lead to distortion being superimposed on the driving voltage waveforms to be applied to the image display device. This results in an impairment of image display quality.

With such problems being present, there is a demand for an image display apparatus that provides a solution to such problems and that accordingly realizes superior image display performance.

In view of such problems, the present invention provides an image display apparatus that realizes superior image display characteristics and reduced device size at the same time, even when an image display device included in the image display apparatus has high definition and/or a large screen size. Such an image display apparatus is realized by enabling facilitated and spatially-efficient electrical connection between the image display device and a circuit board having a driving circuit mounted thereon by utilizing flexible circuit boards.

### Solution to the Problems

In view of the aforementioned problems, the image display apparatus pertaining to one aspect of the present invention is an image display apparatus that comprises an image display device, a circuit board, and a flexible circuit board electrically connecting the image display device and the circuit board, wherein the flexible circuit board is constituted of a plurality of parts including a common circuit part, a first circuit part, and a second circuit part, the first circuit part and the second circuit part extending from one side of the common circuit part separately from each other, the flexible circuit board includes: a plurality of wires, the wires constituted of a first wire extending from the first circuit part to the common circuit part and a second wire extending from the second circuit part to the common circuit part, the first wire and the second wire meeting at the common circuit part so as to form a side-by-side arrangement at the common circuit part when the flexible circuit board is viewed in plan view; a plurality of device connection terminals for connecting the flexible circuit board with the image display device, the device connection terminals disposed at the common circuit part; and a plurality of circuit connection terminals for connecting the flexible circuit board with the circuit board, the circuit connection terminals constituted of a first circuit connection terminal and a second circuit connection terminal respectively disposed at the first circuit part and the second circuit part, in the flexible circuit board, the device connection terminals are electrically connected one-to-one with the circuit connection terminals via the wires, the circuit board includes a first connector disposed at one surface thereof and a second connector disposed at the other surface thereof, and the flexible circuit board is electrically connected with the circuit board by the first circuit connection terminal being connected with the first connector and the second circuit connection terminal being connected with the second connector while the flexible circuit board is folded at at least one of a position within the first circuit part and a position within the second circuit part.

### Advantageous Effects of the Invention

According to the above-described structure, the image display apparatus pertaining to one aspect of the present invention realizes facilitated connection between the electrode terminals provided to the image display device and the circuit board having the driving circuit mounted thereon even when the image display device is a high definition image display device.

### BRIEF DESCRIPTION OF THE DRAWINGS

FIG. 1 is a plan view illustrating a structure of a flexible circuit board in embodiment 1 of the present invention.

FIG. 2 is a perspective view illustrating a folded state of the flexible circuit board in embodiment 1 of the present invention.

FIG. 3 is a plan view illustrating a structure of a flexible circuit board in embodiment 2 of the present invention.

FIG. 4 is a plan view illustrating a structure of a flexible circuit board in embodiment 3 of the present invention.

FIG. 5 is a plan view illustrating a structure of a flexible circuit board in embodiment 4 of the present invention.

FIG. 6 is an exploded perspective view illustrating a panel to be utilized in a plasma display apparatus in embodiment 5 of the present invention.

FIG. 7 is a schematic diagram illustrating an arrangement of display electrode pairs and corresponding electrode terminals provided to a front substrate of the panel in embodiment 5 of the present invention.

FIG. 8 illustrates driving voltage waveforms to be applied to the electrode terminals of the panel utilized in the plasma display apparatus in embodiment 5 of the present invention.

FIG. 9 is a circuit block diagram illustrating the plasma display apparatus in embodiment 5 of the present invention.

FIG. 10 is a diagram illustrating a driving circuit mounted on a circuit board of the plasma display apparatus in embodiment 5 of the present invention.

FIG. 11 is an exploded perspective view illustrating a structure of the plasma display apparatus in embodiment 5 of the present invention.

FIG. 12 is an enlarged view illustrating how flexible circuit boards provide connection in the plasma display apparatus in embodiment 5 of the present invention.

### DESCRIPTION OF EMBODIMENTS

In the following, explanation is provided of embodiments 1 through 4 of the present invention with reference to the accompanying drawings. In specific, in embodiments 1 through 4, explanation is provided of flexible circuit boards which are utilized in the image display apparatus pertaining to the present invention.

### Embodiment 1

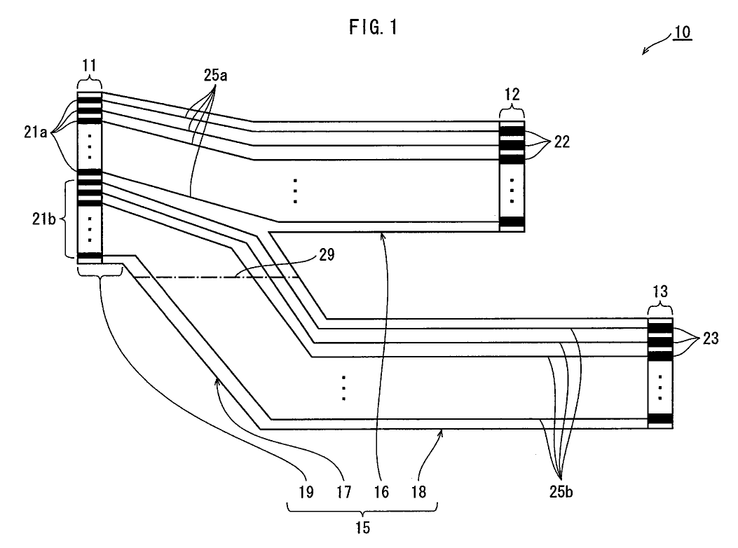

FIG. 1 is a plan view illustrating a structure of a flexible circuit board 10 in embodiment 1 of the present invention.

The flexible circuit board 10 is a flexible circuit board for electrically connecting an image display device and a driving circuit board. The flexible circuit board 10 includes: a first insulative resin film (flexible film); a plurality of wires including wires 25a and wires 25b (the total number of the wires being 270 in this example) that are formed on one surface of the first insulative resin film; and a second insulative resin film (flexible film) that covers the wires 25a and the wires 25b from above. The wires are composed of conductive material such as copper foil. Further, the wires are formed with a predetermined pitch therebetween and hence, the wires exhibit stripes on the surface of the first insulative resin film. In addition, the first insulative resin film and the second insulative resin film are similar to each other in that both insulative resin films are composed of polyimide or the like.

As illustrated in FIG. 1, the flexible circuit board 10 includes: a circuit portion 15; a panel (device) connection portion 11; and circuit connection portions 12 and 13. The circuit portion 15 covers most of the flexible circuit board 10, and the panel connection portion 11, the circuit connection portion 12, and the circuit connection portion 13 are each formed at respective ends of the circuit portion 15.

The circuit portion 15 is the main part of the flexible circuit board 10 and is constituted of a common circuit part 19; a first circuit part 16; a second circuit part 18; and a separating part 17.

The first circuit part 16 has an elongated shape and extends in a first direction (from the left side of FIG. 1 towards the right side of FIG. 1) from the common circuit part 19. Note that in the following, the longitudinal direction of the flexible circuit board 10 in FIG. 1 is referred to as the first direction.

The separating part 17 protrudes from the common circuit part 19 in a direction crossing the first direction, and the second circuit part 18 extends in the first direction from the separating part 17 and has an elongated shape. Here, note that although the first circuit part 16 and the second circuit part 18 are illustrated in the flexible circuit board 10 illustrated in FIG. 1 as being arranged such that a longitudinal direction of the first circuit part 16 and a longitudinal direction of the second circuit part 18 are parallel, the first circuit part 16 and the second circuit part 18 need not be arranged so as to be exactly parallel.

When viewing the flexible circuit board 10 in plan view as illustrated in FIG. 1, the wires 25a extend along the longitudinal direction of the first circuit part 16. Further, the wires 25a are provided in a side-by-side arrangement and constitute a first wire group. On the other hand, the wires 25b extend along the longitudinal direction of the second circuit part 18. Further, the wires 25b are provided in a side-by-side arrangement and constitute a second wire group. In addition, the wires 25a and the wires 25b are disposed so as to meet at the common circuit part 19 and such that, at the common circuit part 19, a predetermined interval (pitch) lies between the wires. Here, note that the predetermined pitch between the wires at the common circuit part 19 is smaller than the pitch between the wires 25a at the first circuit part 16 and the pitch between the wires 25b at the second circuit part 18.

In addition, one end of each of the wires 25a (an end to the left side in FIG. 1, i.e., an end closer to the panel connection portion 11) is electrically connected, in one-to-one correspondence, with a corresponding panel connection terminal (device connection terminal) 21a. The panel connection terminals 21a are formed by externally exposing the wires 25a at the common circuit part 19. Similarly, one end of each of the wires 25b (an end to the left side in FIG. 1, i.e., an end closer to the panel connection portion 11) is electrically connected, in one-to-one correspondence, with a corresponding panel connection terminal (device connection terminal) 21b. The panel connection terminals 21b are formed by externally exposing the wires 25b at the common circuit part 19. On the other hand, the other end of each of the wires 25a (an end to the right side in FIG. 1, i.e., an end closer to the circuit connection portion 12) is electrically connected, in one-to-one correspondence, with a corresponding circuit connection terminal 22. The circuit connection terminals 22 are formed by externally exposing the wires 25a at the first circuit part 16. Similarly, the other end of each of the wires 25b (an end to the right side in FIG. 1, i.e., an end closer to the circuit connection portion 13) is electrically connected, in one-to-one correspondence, with a corresponding circuit connection terminal 23. The circuit connection terminals 23 are formed by externally exposing the wires 25b at the second circuit part 18.

The panel connection terminals (21a and 21b) are disposed in a side-by-side arrangement with a predetermined pitch therebetween. The area of the flexible circuit board 10 at which the panel connection terminals are disposed in a side-by-side arrangement constitutes the panel connection portion 11, which is to be connected with electrode terminals provided to an undepicted image display device, such as a PDP, which is to be connected with the flexible circuit board 10. On the other hand, the circuit connection terminals 22 and the circuit connection terminals 23 are each disposed in a side-by-side arrangement with a predetermined pitch therebetween. Further, the area of the flexible circuit board 10 at which the circuit connection terminals 22 are disposed in side-by-side arrangement constitutes the first circuit connection portion 12, and the area of the flexible circuit board 10 at which the circuit connection terminals 23 are disposed in side-by-side arrangement constitutes the second circuit connection portion 13. The first circuit connection portion 12 and the second circuit connection portion 13 are to be connected with connecters provided to an undepicted driving circuit board which is to be connected with the flexible circuit board 10.

In addition, near a boundary between the separating part 17 and the common circuit part 19, a fold portion 29 (illustrated by using dashed-dotted lines in FIG. 1) exists. The fold portion 29 is provided for folding the second circuit part 18 and the separating part 17 towards the first circuit part 16.

Here, note that the pitch between the panel connection terminals disposed at the panel connection portion 11 is adjusted so as to be in accordance with the pitch between electrode terminals provided to an image display device which is to be connected with the flexible terminal 10. More specifically, the panel connection terminals are to be connected with electrode terminals provided to such an image display device. On the other hand, the pitch between the circuit connection terminals 22 and the pitch between the circuit connection terminals 23 are adjusted so as to be in accordance with the pitch between connection terminals provided in connectors of a driving circuit board that is to be connected with the flexible circuit board. More specifically, the circuit connection terminals are to be connected with connection terminals provided in connectors provided to such a driving circuit board. Further, as explanation has already been provided in the above, the circuit connection terminals 22 and the circuit connection terminals 23 are respectively disposed at the circuit connection portion 12 and the circuit connection portion 13.

Commonly, the pitch between connection terminals provided in a connector mounted on a driving circuit board that is to be connected with the flexible circuit board cannot be reduced to be smaller than a predetermined value. This is since restrictions are imposed on the pitch between such connection terminals (for preventing dielectric breakdowns and the like from occurring in the connector). Such restrictions are based on voltage values and electric current values to be supplied to an image display device connected with the flexible circuit board 10 by such a driving circuit board connected with the flexible circuit board 10.

As such, even though the pitch between electrode terminals provided to an image display device that is to be connected with the flexible circuit board 10 is extremely small especially when the image display device is a high definition PDP or the like, the distance between connection terminals provided in a connector mounted on a driving circuit board that is to be connected with the flexible circuit board 10 is restricted by safety standards and the like. Accordingly, the pitch between the circuit connection terminals 22 and the pitch between the circuit connection terminals 23 respectively disposed at the circuit connection portion 12 and the circuit connection portion 13 are greater than the pitch between the panel connection terminals disposed at the panel connection portion 11.

As such, the flexible circuit board 10 in embodiment 1 is characterized in that the pitch between the panel connection terminals is set so as to be smaller than the pitch between the circuit connection terminals. By the pitch between the connection terminals being set in such a manner, the flexible circuit board 10 provides excellent connection between an image display device and a driving circuit board, each of which is to be connected with the connection terminals of the flexible circuit board 10. To provide a specific example, the total number of the panel connection terminals at the panel connection portion 11 (the panel connection terminals 21a and the panel connection terminals 21b) is set to 270, which equals the number of the wires (the wires 25a and the wires 25b). Further, the pitch between the panel connection terminals 21a and the pitch between the panel connection terminals 21b are set to 0.26 mm, which is in accordance with the pitch between electrode terminals of an image display device that is to be connected with the flexible circuit board 10. On the other hand, the number of the circuit connection terminals 22 disposed at the circuit connection portion 12 and the number of the circuit connection terminals 23 disposed at the circuit connection portion 13 are each set to 135. Further, the pitch between the circuit connection terminals 22 and the pitch between the circuit connection terminals 23 are set to 0.42 mm, which is in accordance with the pitch between connection terminals in connectors provided to a driving circuit board that is to be connected with the flexible circuit board 10. In the flexible circuit board 10, the pitch between the circuit connection terminals is set so as to be greater than the pitch between the panel connection terminals. Further, the pitch between the wires 25a is adjusted so as to change in accordance with the change in pitch between the circuit connection terminals 22 and the panel connection terminals 21a, and similarly, the pitch between the wires 25b is adjusted so as to change in accordance with the change in pitch between the circuit connection terminals 23 and the panel connection terminals 21b.

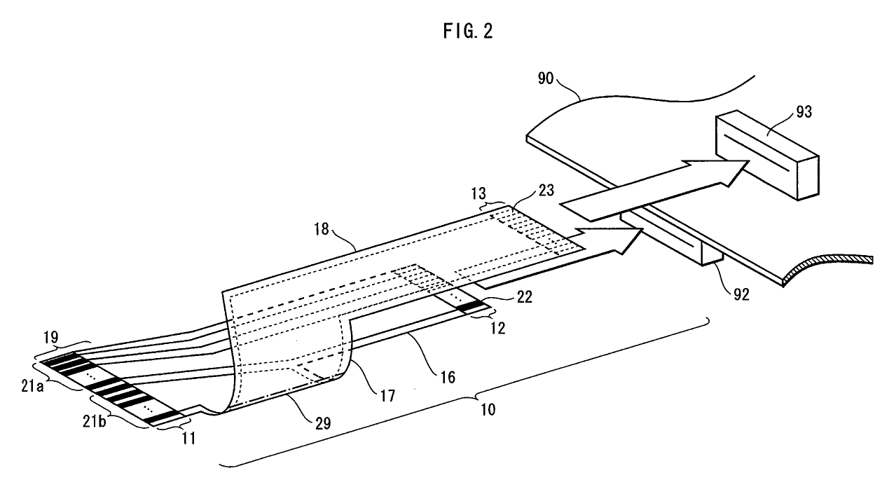

Subsequently, explanation is provided of an example of the procedures for connecting the flexible circuit board 10 with a driving circuit board that is to be connected therewith. FIG. 2 is a perspective view illustrating how the flexible circuit board 10 is connected with a circuit board 90. A connector 92 is disposed at one surface of the circuit board 90, and a connector 93 is disposed at the other surface of the circuit board 90. The connectors 92 and 93 are each disposed at one surface of the circuit board 90 and at an area near one lateral edge portion of the circuit board 90. Further, the connectors 92 and 93 are arranged so as not to overlap each other with the circuit board 90 in between. The connectors are arranged in this manner taking into consideration restrictions imposed on the arrangement of the connectors in actual implementation.

When connecting the flexible circuit board 10 with the circuit board 90, firstly, the separating part 17 and the second circuit part 18 are lightly folded along the fold portion 29 as illustrated in FIG. 2. Subsequently, the circuit connection portion 12, which is provided at an end of the first circuit part 16, is inserted into the connector 92, which is disposed at a rear surface of the circuit board 90. In the meantime, the circuit connection portion 13, which is provided at an end of the second circuit part 18, is inserted into the connector 93, which is disposed at a front surface of the circuit board 90. The first circuit part 16 and the second circuit part 18 of the flexible circuit board 10 extend separately from the common circuit part 19, and the flexible circuit board 10 is lightly folded with the application of moderate force along the fold portion 29. Hence, the circuit connection portions 12 and 13 can be respectively connected with the connectors 92 and 93 provided to the circuit board 90 with ease.

Concerning the extent to which the flexible circuit board 10 is to be folded, there is no need of completely or sharply folding the flexible circuit board 10 such that a fold line is formed on the flexible circuit board 10. In fact, the folded state of the flexible circuit board 10 refers to a state where the flexible circuit board 10 is lightly folded along the fold portion 29 such that the flexible circuit board 10 exhibits a moderate curvature as illustrated in FIG. 2.

In addition, the panel connection portion 11 is connected with an undepicted image display device, such as a PDP, which is to be connected with the flexible circuit board 10.

In the flexible circuit board 10, the first circuit part 16 and the second circuit part 18 are provided so as to extend separately from the common circuit part 19. Hence, once the flexible circuit board 10 has been lightly folded along the fold portion 29, there is no need of further folding the folded portion of the flexible circuit board 10 in a different direction. Accordingly, the flexible circuit board 10 can be connected with the circuit board 90 while maintaining a desirable form and while preventing damage and deterioration thereof. Hence, the flexible circuit board 10 is expected to exhibit longevity. In addition, the electrode terminals (the panel connection terminals 21a and 21b, and the circuit connection terminals 12 and 13) are provided to the flexible circuit board 10 such that the pitch between the electrode terminals changes appropriately on the flexible circuit board 10. Hence, the flexible circuit board 10 is not influenced by the restrictions imposed on the pitch between the connection terminals in the connectors 92 and 93 provided to the circuit board 90. As such, the flexible circuit board 10 realizes excellent electrical connection between an undepicted image display device and the circuit board 90.

In other words, as explanation has been provided in the above, the pitch between the circuit connection terminals 22 and the pitch between the circuit connection terminals 23 respectively provided at the circuit connection portion 12 and the circuit connection portion 13 are set so as to be greater than the pitch between the panel connection terminals (the panel connection terminals 21a and the panel connection terminals 21b) provided at the panel connection portion 11 in accordance with restrictions imposed on the circuit board 90 and the connectors 92 and 93 mounted thereon due to specifications thereof. Accordingly, the total width of the circuit connection portion 12 and the circuit connection portion 13 is greater than the width of the panel connection portion 11. However, by respectively connecting the circuit connection portion 12 and the circuit connection portion 13 with the connector 92 and the connector 93 disposed at respective surfaces of the circuit board 90 while folding the flexible circuit board 10 in the above-described manner, excellent electrical connection can be realized between the circuit connection portions and a driving circuit board that is to be connected with the flexible circuit board 10. As explanation has been provided above, the total width of the circuit connection portion 12 and the circuit connection portion 13 is greater than the width of the panel connection portion 11 due to restrictions imposed on the pitch between the circuit connection terminals 22 and the pitch between the circuit connection terminals 23. In addition to this, since, in appearance, the flexible circuit board 10 occupies a width on the respective surfaces of the circuit board 10 that falls within a similar range as the width of the first circuit part 16 or the second circuit part 18 (i.e., the width of the panel connection portion 11) when connected with the circuit board 10, even though the total width of the circuit connection portion 12 and the circuit connection portion 13 is comparatively great, the flexible circuit board 10 can be connected with the circuit board 90 while realizing high spatial efficiency. As such, even when a plurality of connectors (92 and 93) are formed on the circuit board 90 and the connectors are arranged at a certain degree of closeness with respect to each other (e.g., when the connectors 92 and the connectors 93 are each arranged in a line on the corresponding surface of the circuit board 90), a plurality of the flexible circuit boards 10 can be connected to the circuit board 90 while not occupying much space. Hence, even when a high definition PDP, in which the pitch between electrode terminals is relatively small, is to be connected with a driving circuit board, excellent electrical connection can be realized by connecting a plurality of the flexible circuit boards 10 with the electrode terminals of the PDP in an aligned state and by connecting the flexible circuit boards 10 with the connectors 92 and the connectors 93 disposed on the circuit board 90 in a compact state. Further, since the connectors 92 and the connectors 93 can each be arranged in a line on the corresponding surface of the circuit board 90 at a certain degree of closeness with respect to each other, the flexible circuit boards 10 can be connected to the circuit board 90 while being arranged with a certain degree of closeness with respect to each other. This contributes to the downsizing of the image display apparatus including the flexible circuit board 10 and the circuit board 90.

Note that in the example structure explained above, examples of the number of the connection terminals (the panel connection terminals 21a and 21b, and the circuit connection terminals 22 and 23) are provided for the sake of exemplification. More specifically, explanation is provided that the number of the panel connection terminals 21a disposed and the number of the panel connection terminals 21b disposed are each 135, and the number of the circuit connection terminals 22 disposed and the number of the circuit connection terminals 23 disposed are each 135. In the above-described example, the number of the circuit connection terminals 22 disposed equals the number of the circuit connection terminals 23 disposed. Further, the total number of the circuit connection terminals (22 and 23) disposed equals the total number of the panel connection terminals (21a and 21b) disposed. However, the number of each of the terminals provided to the flexible circuit board 10 is not limited to the numbers explained above, and further, the relation between the respective numbers of the terminals disposed is not limited to fulfilling the above-described relation. That is, the number of the circuit connection terminals 22 disposed may differ from the number of the circuit connection terminals 23 disposed, and the total number of the circuit connection terminals (22 and 23) disposed need not equal the total number of the panel connection terminals (21a and 21b) disposed. In addition, dummy terminals may also be included in the number of terminals provided to the flexible circuit board 10. For instance, when dummy terminals are disposed at the circuit connection portion 12 and the circuit connection portion 13, the total number of the circuit connection terminals (22 and 23) disposed may be set to be greater than the total number of the panel connection terminals (21a and 21b) disposed.

In addition, to provide another example, presumption is made of a case where a plurality of integrated circuits for generating driving voltage waveforms to be applied to an image display device included in the image display apparatus are mounted on a driving circuit board included in the image display apparatus. Further, it is presumed in this example that, for instance, each of the integrated circuits outputs driving voltage waveforms corresponding to 90 electrode terminals of the image display device. In such a case, the number of the circuit connection terminals 22 disposed at the circuit connection portion 12 may be set to 180, which corresponds to two of the above-described integrated circuits. On the other hand, the number of the circuit connection terminals 23 disposed at the circuit connection portion 13 may be set to 90, which corresponds to one of the above-described integrated circuits. As such, the number of the circuit connection terminals 22 disposed may differ from the number of the circuit connection terminals 23 disposed. In addition, although the number of each of the circuit connection terminals 22 and the circuit connection terminals 23 disposed is set to an integral multiple of the number of outputs provided to the integrated circuit in the above-described example, the number of each of the circuit connection terminals 22 and the circuit connection terminals 23 disposed may be set regardless of the number of outputs provided to the integrated circuit.

In the following, explanation is provided of other embodiments of the present invention one by one while mainly focusing on aspects differing from embodiment 1.

### Embodiment 2

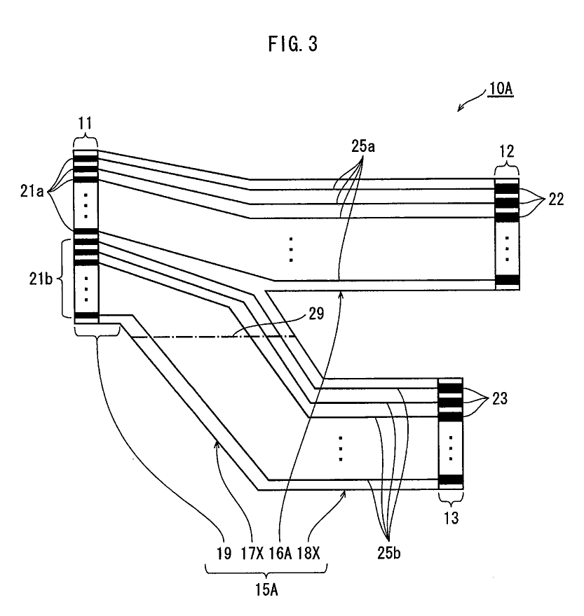

FIG. 3 is a plan view illustrating a structure of a flexible circuit board 10A in embodiment 2 of the present invention.

The overall shape of the flexible circuit board 10A is similar to the shape of the flexible circuit board 10. A circuit portion 15A of the flexible circuit board 10A includes: the common circuit part 19; a first circuit part 16A extending from the common circuit part 19; a separating part 17X; a second circuit part 18X extending in a longitudinal direction of the first circuit part 16A from the common circuit part 19 via the separating part 17X. The flexible circuit board 10A differs from the flexible circuit board 10 in that lengths of the wires 25a and 25b are arranged to be equal. Accordingly, electric current paths extending from the panel connection terminals 21a to the circuit connection terminals 22 and electric current paths extending from the panel connection terminals 21b to the circuit connection terminals 23 have the same length.

Note that, when electric current paths are referred to as having the same length, the electric current paths are not limited to having exactly the same length, but instead, cases are included where the electric current paths have different lengths with respect to each other within an error range of ±5%. Such cases are included taking into account design errors that may occur in actual implementation of flexible circuit boards. In addition, due to the wires 25a and the wires 25b being provided with the same length as described above, the length of the second circuit part 18X in the flexible circuit board 10A is shorter than the length of the second circuit part 18 in the flexible circuit board 10.

By making such an arrangement, in the flexible circuit board 10A, an equal impedance is realized along (i) the electric current paths connecting the panel connection terminals 21a and the circuit connection terminals 22 and (ii) the electric current paths connecting the panel connection terminals 21b and the circuit connection terminals 23. This allows for improved image display performance of an image display device that is to be connected with the flexible circuit board 10A. Explanation is provided in the following of the reasons as to why the image display performance of an image display device that is to be connected with the flexible circuit board 10A is improved by making such an arrangement in the flexible circuit board 10A.

As explanation is provided in embodiment 5, there is a necessity of causing a high peak current to flow through, for instance, the scan electrodes of a PDP, during a sustain period. If indifference exists in the impedance of the respective electric current paths leading to the scan electrodes of such a PDP during the sustain period, indifference is also generated in ringing superimposed on driving voltage waveforms. Due to this, there is a risk of degradation of image display quality.

In view of such a problem, in an image display apparatus in which a driving circuit board and an image display device (PDP) are electrically connected by using the flexible circuit board 10A, the impedance of the electric current paths along the wires leading to the scan electrodes is substantially equalized, and thus, the indifference in ringing is suppressed. Hence, an image display apparatus exhibiting superior image display performance is realized.

### Embodiment 3

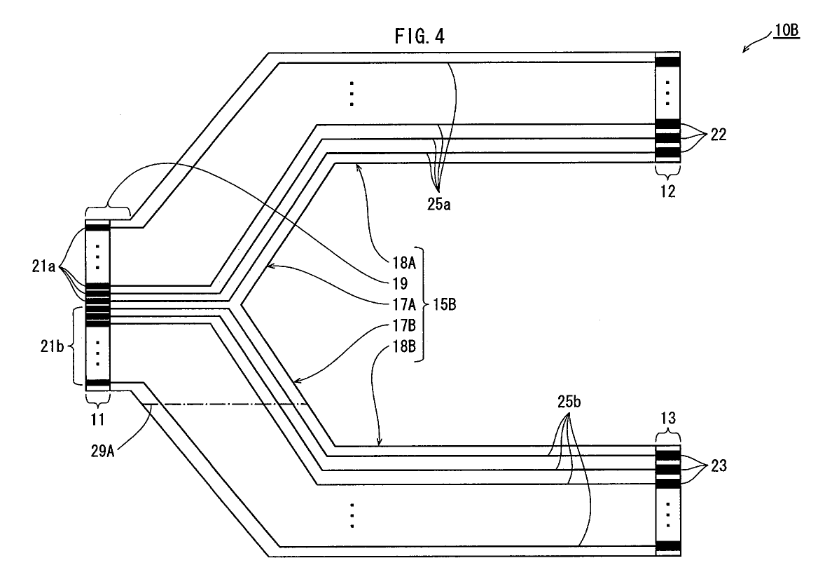

FIG. 4 is a plan view illustrating a structure of a flexible circuit board 10B in embodiment 3 of the present invention.

The flexible circuit board 10B includes a circuit portion 15B. In the circuit portion 15B, a separating part 17A and a first circuit part 18A are formed so as to extend from the common circuit part 19, and a separating part 17B and a second circuit part 18B are formed so as to extend from the common circuit part 19. Further, in the flexible circuit board 10B, the combination of the separating part 17A the first circuit part 18A exhibits symmetry with respect to the combination of the separating part 17B and the second circuit part 18B. In addition, in the flexible circuit board 10B, the fold portion 29 is to be provided within either the separating part 17A or the separating part 17B. FIG. 4 illustrates a structure where a fold portion 29A is provided within the separating part 17B. Further, in the flexible circuit board 10B, the first circuit part 18A is provided so as to extend from the separating part 17A.

The flexible circuit board 10B having such a structure realizes the same effects as the flexible circuit board 10 in embodiment 1. In addition, since the wires 25a and the wires 25b have the same length in the flexible circuit board 10B similar as in embodiment 2, the electric current paths have equivalent lengths. Hence, the flexible circuit board 10B also has an advantageous effect of realizing uniform impedance characteristics.

### Embodiment 4

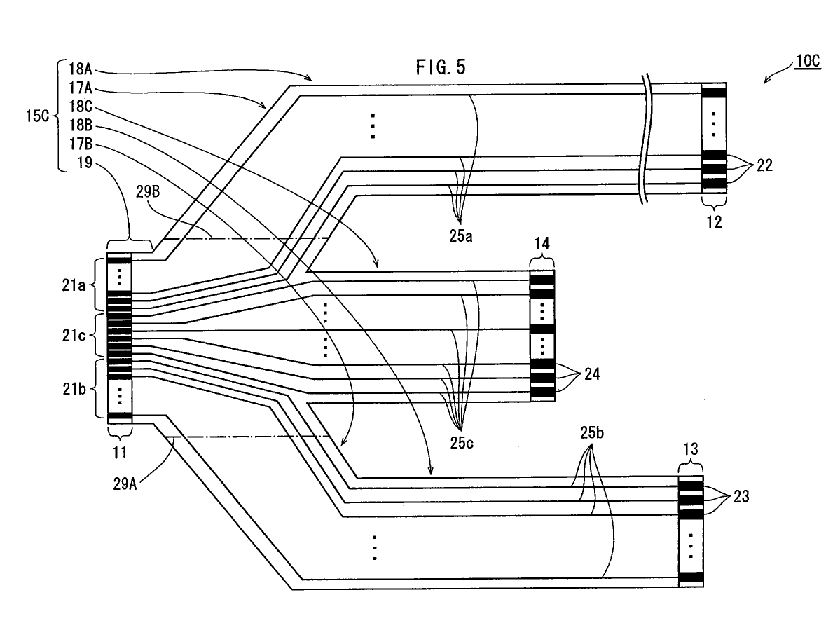

FIG. 5 illustrates a structure of a flexible circuit board 10C in embodiment 4.

The flexible circuit board 10C includes a circuit portion 15C having the same basic structure as the flexible circuit board 10B in embodiment 3, and further includes a third circuit part 18C extending from the common circuit part 19. The first circuit part 18A, the second circuit part 18B, and the third circuit part 18C are elongated members extending parallely to each other with a predetermined distance therebetween. Further, the length of the first circuit part 18A in the longitudinal direction of the first circuit part 18A, the length of the second circuit part 18B in the longitudinal direction of the second circuit part 18B, and the length of the third circuit part 18C in the longitudinal direction of the third circuit part 18C differ from each other. In the example structure illustrated in FIG. 5, the circuit parts are adjusted so as to have a greater length in the order of: the first circuit part 18A; the second circuit part 18B; and the third circuit part 18C. However, this order is merely provided as one example, and the relation between the lengths of the circuit parts is not limited to this order. In addition, the first circuit part 18A, the second circuit part 18B, and the third circuit part 18C are respectively provided with a circuit connection portion 12, a circuit connection portion 13, and a circuit connection portion 14. Each circuit connection portion is provided at a longitudinal-direction end of the corresponding circuit section. Further, circuit connection terminals 22, circuit connection terminals 23, and circuit connection terminals 24 are respectively provided at the circuit connection portion 12, the circuit connection portion 13, and the circuit connection portion 14. In specific, the circuit connection terminals are disposed at a corresponding circuit connection portion with a predetermined pitch therebetween. Additionally, the circuit portion 18A, the circuit portion 18B, and the circuit portion 18C are respectively provided with the wires 25a, the wires 25b, and wires 25c. In addition, panel connection terminals 21a, panel connection terminals 21b, and panel connection terminals 21c are disposed at the panel connection portion 11 of the common circuit part 19. The panel connection terminals 21a, the panel connection terminals 21b, and the panel connection terminals 21c are respectively connected with the wires 25a, the wires 25b, and the wires 25c. Further, each of the panel connection terminals 21a, the panel connection terminals 21b, and the panel connection terminals 21c is disposed with a predetermined pitch therebetween.

Further, a fold portion 29A and a fold portion 29B are respectively provided within a separating part 17A and a separating part 17B.

The flexible circuit board 10C having the above-described structure can be easily connected with a driving circuit board that has (i) a first connector provided on one surface thereof and (ii) a second connector and a third connector provided in series on the other surface thereof.

When connecting the flexible circuit board 10C to the driving circuit board having the above-described structure, firstly, the circuit connection portion 14 is connected to the first connector provided on one surface of the driving circuit board. Subsequently, the separating part 17 and the first circuit part 18A are folded towards the depth direction in FIG. 5 at the fold portion 29A, and the circuit connection portion 12 is inserted into the second connector provided to the other surface of the driving circuit board. Similarly, the separating part 17B and the second circuit part 18B are folded towards the depth direction in FIG. 5 at the fold portion 29B, and the circuit connection portion 13 is inserted into the third connector provided to the other surface of the driving circuit board. In this case, since the first circuit part 18A, the second circuit part 18B, and the third circuit part 18C have different lengths, the circuit connection portions 12 through 14 can be efficiently connected with the three connectors provided to the above-described driving circuit board especially when the three connectors are provided in series to the driving circuit board when the driving circuit board is viewed in plan view.

Subsequently, as embodiment 5 of the present invention, explanation is provided of an example structure of an image display apparatus realized by utilizing the flexible circuit boards 10 pertaining to embodiment 1, with reference to the accompanying drawings.

### Embodiment 5

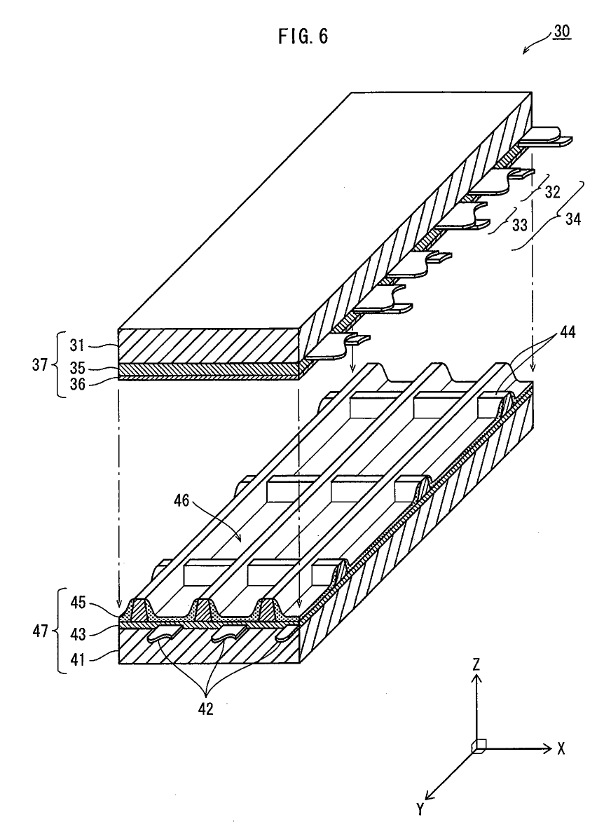

FIG. 6 is an exploded perspective view illustrating a panel (PDP) utilized in a plasma display apparatus in embodiment 5 of the present invention.

A PDP 30 has a rectangular display surface and includes a front substrate (front panel) 37 and a back substrate (back panel) 47, which are disposed to face each other with a discharge space in between. Further, the front substrate 37 and the back substrate 47 are sealed by sealing being provided at peripheries thereof, and a discharge gas is enclosed in the discharge space.

In specific, the front substrate 37 includes a front panel glass 31 and a plurality of display electrode pairs 34 disposed in a side by side arrangement on a surface of the front panel glass 31. Each of the display electrode pairs is composed of a scan electrode 32 and a sustain electrode 33. The scan electrodes and the sustain electrodes each exhibit a stripe pattern on the surface of the front panel glass 31. Further, a dielectric layer 35 having a predetermined dielectric constant is formed so as to cover the display electrode pairs 34, and a protective layer 36 that protects the dielectric layer 35 from impact of electric discharge and that has a secondary electron emission characteristic is formed above the dielectric layer 35.

On the other hand, the back substrate 47 includes a back panel glass 41 and a plurality of data (address) electrodes 42 disposed in a side by side arrangement on one surface of the back panel glass 41 facing the surface of the front panel glass 31 so as to be parallel with each other. The data electrodes 42 exhibit a strip pattern on the surface of the back panel glass 41. Further, a dielectric layer 43 is formed so as to cover the data electrodes 42. On a surface of the dielectric layer 43, banks 44 are formed so as to exhibit a grid pattern. Above each area defined by (i) lateral surfaces of the banks 44 and (ii) a surface of the dielectric layer 43 surrounded thereby, a phosphor layer 45 corresponding to one of the colors R, G, and B is formed.

Note that the scan electrodes 32, the sustain electrodes 33, and the data electrodes 42 are connected one-to-one with electrode terminals provided at a peripheral region of the front substrate 37. The peripheral region is located outside an image display region of the front substrate 37, and the electrode terminals are provided at the peripheral region with a predetermined pitch therebetween. As explanation has already been provided in the above, a combination of a scan electrode 32 and a corresponding sustain electrode 33 composes a display electrode pair 34. In particular, when the PDP 30 is a ultra high definition panel, n denoting the number of the scan electrodes 32 and the number of the sustain electrodes satisfies, for instance, n=2160.

The front substrate 37 and the back substrate 47 are disposed facing each other with a discharge space 46 having a microscopic size therebetween, as explanation is provided in the above. Here, it should be noted that the front substrate 37 and the back substrate 47 are disposed in the above-described manner while the display electrode pairs 34 and the data electrodes 42 cross each other. Further, sealing is provided between the front substrate 37 and the back substrate 47 in the periphery of the front substrate 37 and the periphery of the back substrate 47 by using a sealing material that includes glass frit or the like. Further, a discharge gas composed of, for instance, a mixture gas of Ne and Xe is enclosed at a predetermined pressure in the discharge space 46.

The discharge space 46 is partitioned into a plurality of sections by the banks 44, and a discharge cell is formed at each of positions where the discharge electrode pairs 34 and the data electrodes 42 cross each other. As such, when the PDP 30 has, for instance, (i) an n number of scan electrodes and an n number of sustain electrodes, which are longer in the row direction, arranged on the front panel glass 31 and (ii) an m number of data electrodes 42, which are longer in the column direction, arranged on the back panel glass 41, the PDP 30 has a total of m×n number of discharge cells formed therein.

When the PDP 30 having such a structure is driven, a write discharge is caused to occur in one of the discharge cells between a corresponding scan electrode 32 and a corresponding data electrode 42. A discharge cell that is to perform light-emission is specified in this manner, and subsequently, a sustain discharge is generated between a display electrode pair 34 corresponding to the discharge cell. The phosphor layer 45 transforms UV light emitted when the sustain discharge is generated into visible light, and a predetermined image is displayed by the visible light being extracted to the outside of the PDP 30. For instance, when an m×n number of discharge cells are formed in the PDP 30, a region of the front substrate 37 within which the m×n number of discharge cells are formed constitutes the image display region of the PDP 30.

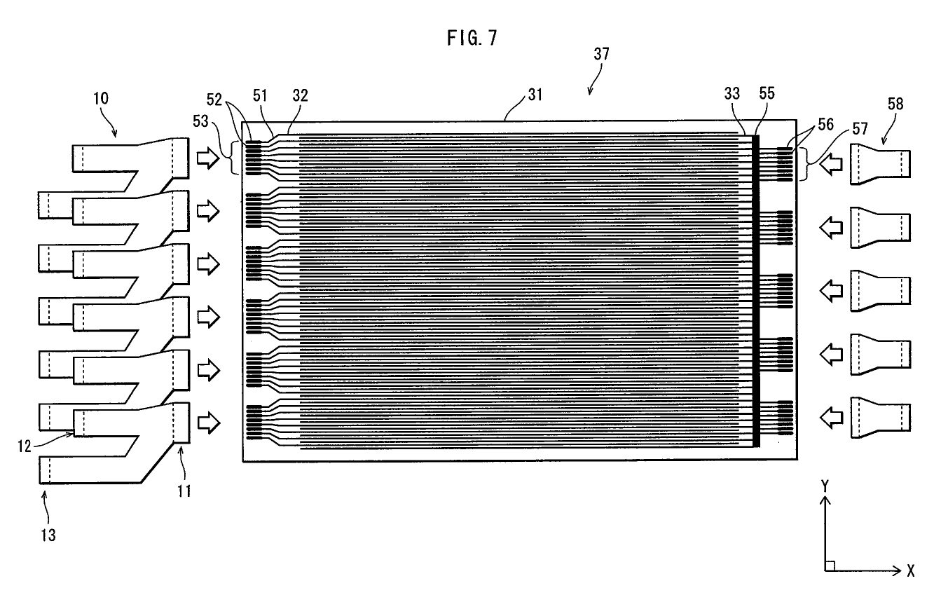

FIG. 7, is a schematic diagram illustrating a relation between an arrangement of the display electrode pairs 34 (each composed of a scan electrode 32 and a sustain electrode 33) and an arrangement of electrode terminals 52 and 56 on the front panel glass 31.

A different driving voltage is to be applied to each of the scan electrodes 32. So as to apply a different driving voltage to each of the scan electrodes 32, each of the scan electrodes 32 is independently connected to a corresponding scan electrode electrode terminal 52 by a lead wire 51. Note that the scan electrode electrode terminals 52 are provided at a peripheral region of the front panel glass 31 that is located to the right side of the image display region when viewed from the side of the display surface (i.e. the peripheral portion illustrated in the left side of FIG. 7). The scan electrode electrode terminals 52 are arranged such that a predetermined number of scan electrode electrode terminals 52 are grouped together so as to form a plurality of electrode terminal groups 53. The electrode terminal groups 53 are formed for connection with the panel connection portions 11 of the flexible circuit boards 10 in embodiment 1. In FIG. 7, the number of scan electrodes 32 illustrated is 48, and the number of scan electrode electrode terminals 52 illustrated is 48. Further, the scan electrode electrode terminals 52 are grouped into six electrode terminal groups 53, each including eight scan electrode electrode terminals 52.

For instance, in the present embodiment, the total number of scan electrodes 32 is 2,160. In this example, the scan electrode electrode terminals 52 can be grouped into eight electrode terminal groups 53, each including 270 scan electrode electrode terminals 52. Further, in this example, one flexible terminal 10 is connected with each of the electrode terminal groups 53, and therefore, a total of eight flexible terminals 10 are connected with the PDP 30.

In contrast, a uniform driving voltage is to be applied to the sustain electrodes 33. Therefore, the sustain electrodes 33 are connected to a short circuit wire 55 for simultaneously applying voltages having a uniform electrical potential. Further, so as to connect the short circuit wire 55 and a plurality of flexible circuit boards 58, the sustain electrode electrode terminals 56 are grouped into a plurality of electrode terminal groups 57. The sustain electrode electrode terminals 56 are provided at a peripheral portion of the front panel glass 31 that is located to the left side of the image display region when viewed from the side of the display surface (i.e. the peripheral portion illustrated in the right side of FIG. 7).

Note that the connection of wires illustrated in FIG. 7 is merely provided as one example. That is, the sustain electrodes 33 may be grouped into a plurality of sustain electrode groups so that a different driving voltage waveform may be applied to each sustain electrode group. In such a case, short circuit connections are to be formed by connecting the sustain electrodes 33 to which the same driving voltage waveform is to be applied by using short circuit wires, and a flexible circuit board 58 may be connected to each of such short circuit wires.

Note that the numbers of the scan electrodes 32 and the sustain electrodes 33 illustrated in FIG. 7 are smaller than the actual numbers thereof. The numbers of the scan electrodes 32 and the sustain electrodes 33 illustrated in FIG. 7 are reduced in such a manner for the sake of facilitating understanding. As a matter of course, the numbers of the scan electrodes 32 and the sustain electrodes 33 are not limited to the numbers illustrated in FIG. 7.

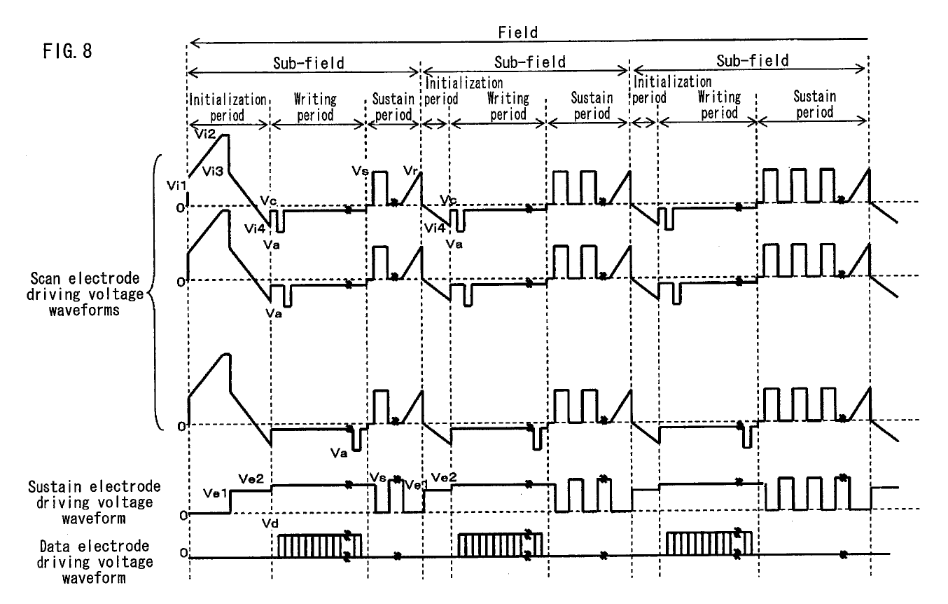

In the following, explanation is provided of one example of the driving voltage waveforms for driving the PDP 30, with reference to FIG. 8.

As illustrated in FIG. 8, a so-called time division display method may be adopted as the method for driving the PDP 30. The time division display method involves dividing a time period corresponding to one field into a plurality of sub-fields and displaying an image by controlling emission/non-emission of light from the discharge cells within each sub-field. Further, according to the time division display method, each sub-field is constituted of an initialization period, a writing period, and a sustain period. In FIG. 8, illustration is provided of driving voltage waveforms applied to the PDP 30 during three sub-fields. Note that the driving voltage waveforms applied to the PDP 30 during other sub-fields existing in the field are similar to the driving voltage waveforms illustrated in FIG. 8.

As illustrated in FIG. 8, in the initialization period of the first sub-field, a voltage of 0 V is applied to the data electrodes 42 and the sustain electrodes 33, and a lamp voltage slowly rising from a voltage Vi1 towards a voltage Vi2 is applied to the scan electrodes 32. Following this, a voltage Ve1 is applied to the sustain electrodes 33, and a lamp voltage slowly decreasing from a voltage Vi3 towards a voltage Vi4 is applied to the scan electrodes 32. When voltage is applied in the above-described manner, a feeble initialization discharge occurs within each of the discharge cells. Further, a wall voltage that is required for the subsequent writing operation accumulates at areas within the discharge cells near the scan electrodes 32, the sustain electrodes 33, and the data electrodes 42.

Note that the above-described operation during the initialization period may be replaced by an operation of merely applying a lamp voltage that decreases slowly to the scan electrodes 32 while maintaining the electric potentials of the data electrodes 42 and the sustain electrodes 33. Such an operation is illustrated in FIG. 8 in the initialization periods of the second and third sub-fields.

In the following writing period, firstly, a voltage Ve2 is applied to the sustain electrodes 33, and a voltage Vc is applied to the scan electrodes 32. Subsequently, a scan pulse voltage Va is applied to the scan electrodes 32 that initially perform the writing operation, and at the same time, a writing pulse voltage Vd is applied to the data electrodes 42 corresponding to the discharge cells that are to emit light. When the scan pulse voltage and the writing pulse voltage are applied in the above-described manner, a writing discharge occurs at each of the discharge cells to which the scan pulse and the writing pulse have been simultaneously applied, and a writing operation of accumulating a wall voltage on the scan electrodes 32 and the sustain electrodes 33 corresponding to such discharge cells is performed.

Subsequently, a scan pulse is applied to the scan electrodes 32 that are to subsequently perform the writing operation, and at the same time, a writing pulse is applied to the data electrodes 42 corresponding to the discharge cells that are to emit light. When the scan pulse and the writing pulse are applied in the above-described manner, a writing discharge occurs at each of the discharge cells to which the scan pulse and the writing pulse have been simultaneously applied, and a writing operation is thereby performed. The above-described writing operation is performed in all of the discharge cells that are to emit light. That is, the writing discharge is selectively generated in the discharge cells that are to emit light, and a wall voltage is accumulated in such discharge cells.

As explanation is provided in the above, a different driving voltage needs to be applied to each of the scan electrodes 32. In addition, the difference between the voltage Vc and the voltage Va is commonly within the range of approximately 50 V-150 V. Due to this difference in voltage, restrictions are imposed on (i) the pitch between the circuit connection terminals 22 and the circuit connection terminals 23 respectively disposed at the circuit connection portion 12 and the circuit connection portion 13 of the flexible circuit board 10 and (ii) the minimum distance between terminals provided in connectors mounted on a driving circuit board, which are to be connected to the circuit connection terminals 22 and the circuit connection terminals 23.

In the subsequent sustain period, a voltage of 0 V is applied to the sustain electrodes 33. Further, a sustain pulse voltage Vs is applied to the scan electrodes 32. When voltage is applied in the above-described manner, a sustain discharge occurs within each of the discharge cells within which the writing discharge has occurred, and the discharge cells are caused to emit light.

Subsequently, a voltage of 0 V is applied to the scan electrodes 32, and a sustain pulse voltage Vs is applied to the sustain electrodes 33. When voltage is applied in the above-described manner, a sustain discharge occurs once more within each of the discharge cells within which the sustain discharge has occurred, and the discharge cells are caused to emit light once again. Following this point, discharge cells are caused to emit light by a sustain pulse in accordance with brightness weight being applied in alternation to the scan electrodes 32 and the sustain electrodes 33.

When the discharge cells are caused to emit light in the above-described manner, a high peak current flows through the scan electrodes 32 due to electric discharge. Due to a necessity of causing the peak current to flow stably through the scan electrodes 32, restrictions are imposed on (i) the thickness of wires provided to a circuit board to be connected with the PDP 30 and (ii) the minimum width of connection terminals disposed at circuit connection portions of flexible circuit boards to be connected with the PDP 30.

At the end of the sustain period, a lamp voltage that slowly rises towards a voltage Vr is applied to the scan electrodes 32 so as to weaken the wall voltage on the scan electrodes 32 and the sustain electrodes 33 while maintaining the positive wall voltage on the data electrodes 42. As such, the sustain operation performed during the sustain period is concluded.

Operations similar to the above-described operations are performed during the subsequent sub-fields as well. By performing the above-described operations of the time division display method, in which a period corresponding to one field is divided into a plurality of sub-fields and control is performed of sub-fields in which discharge cells are caused to emit light, gradation display is realized.

Note that, in a high definition panel having a great number of pixels, the application of the above-described time division driving method to each of the display electrode pairs 34 may give rise to problems. That is, there is a risk of an excessively long period time being required for the execution of the writing operation, and due to this, it may become difficult to divide a field into a sufficient number of sub-fields for realizing gradation display. However, in such a case, a countermeasure can be taken of, for instance, dividing the display electrode pairs 34 into multiple display electrode pair groups, and applying the above-described time division driving method with respect to each of such display electrode pair groups. By taking such a countermeasure, a field can be divided into a sufficient number of sub-fields required for gradation display.

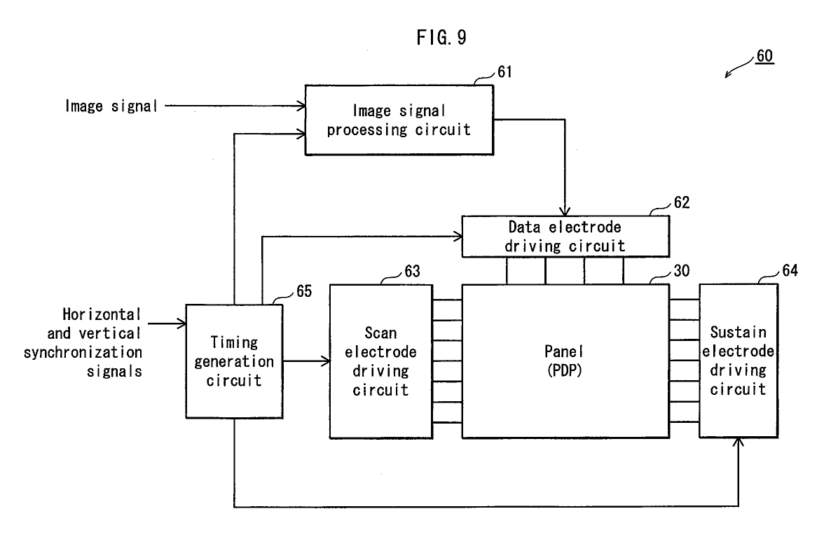

FIG. 9 is a circuit block diagram of a plasma display apparatus 60 in embodiment 5 of the present invention.

As illustrated in FIG. 9, the plasma display apparatus 60 includes: the PDP 30; an image signal processing circuit 61; a data electrode driving circuit 62; a scan electrode driving circuit 63; a sustain electrode driving circuit 64; a timing generation circuit 65; and a power supply unit (undepicted). The power supply unit supplies each of the above-described circuit blocks with power required thereby.

The image signal processing circuit 61 converts an image signal input thereto into image data indicating emission/non-emission of light for each sub-field. The data electrode driving circuit 62 converts the image data for each sub-field into a writing pulse to be applied to each of the data electrodes 42. The timing generation circuit 65 generates various timing signals for controlling the operation of each of the circuit blocks and supplies the timing signals to the corresponding circuit blocks. Note that the generation of the timing signals by the timing generation circuit 65 is performed in accordance with horizontal synchronization signals and vertical synchronization signals. The scan electrode driving circuit 63 generates driving voltage waveforms to be applied to the respective scan electrodes 32 according to the timing signal received. The sustain electrode driving circuit 64 generates a driving voltage waveform to be applied to the sustain electrodes 33 according to the timing signal received. Such driving circuits are implemented by using a plurality of circuit boards.

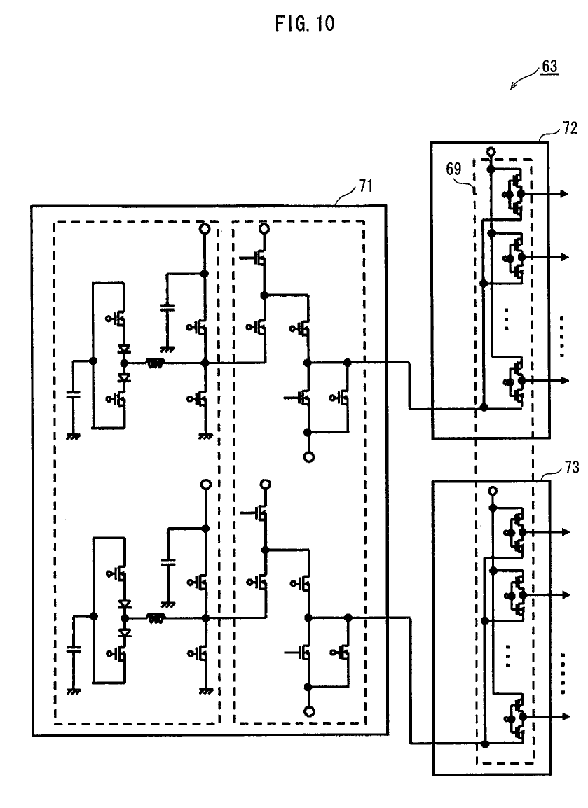

FIG. 10 illustrates a driving circuit mounted on circuit boards of the plasma display apparatus 60 in embodiment 5 of the present invention. More specifically, FIG. 10 illustrates one example of the scan electrode driving circuit 63.

In the example structure illustrated in FIG. 10, a sustain pulse generating unit and an initializing waveform generation unit of the scan electrode driving circuit 63 are mounted on a circuit board 71. The sustain pulse generating unit generates a sustain pulse, and the initializing waveform generating unit generates an initializing waveform. In addition, a scan pulse generating unit 69 of the scan electrode driving circuit 63 mounted in a divided state on a circuit board 72 and a circuit board 73. The scan pulse generating unit 69 generates a scan pulse.

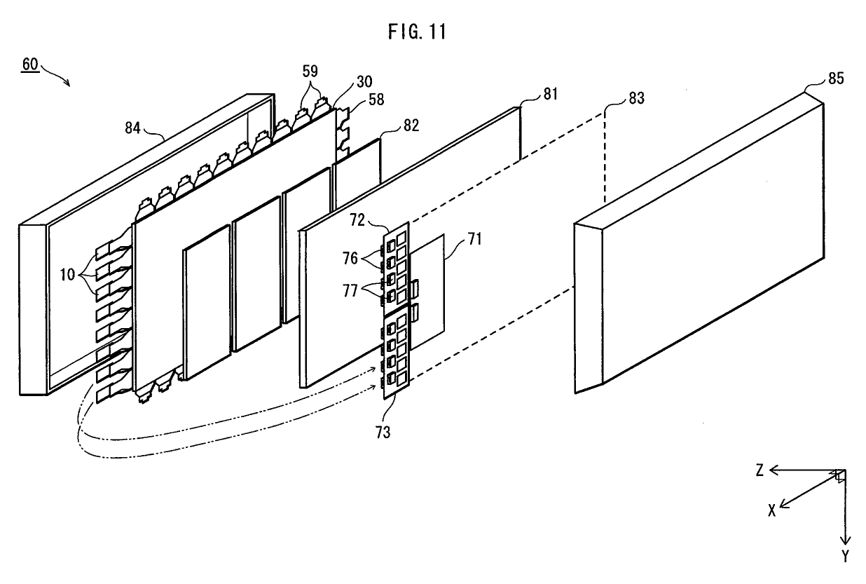

FIG. 11 is an exploded perspective view illustrating a structure of the plasma display apparatus 60, which is the image display apparatus in embodiment 5 of the present invention.

In the plasma display apparatus 60, the PDP 30 is attached to a chassis 81 via a plurality of heat conduction sheets 82. More specifically, the chassis 81 is attached to a rear surface of the PDP 30 via the heat conduction sheets 82. Further, a power supply circuit board and the driving circuit boards (a circuit board group 83 having the scan electrode driving circuit, the sustain electrode driving circuit, the timing generation circuit and the like for driving the PDP 30 mounted thereon) are disposed at a rear surface of the chassis 81. The PDP 30 and the circuit board group 83 are electrically connected via the flexible circuit boards 10, the flexible circuit boards 58, and the flexible circuit boards 59. Further, the above-described components of the plasma display apparatus 60 are accommodated between a front frame 84 and a back cover 85.

When viewing the plasma display apparatus 60 in detail, the scan electrode electrode terminals 52 are provided to one short side of the PDP 30 (a short side illustrated further in the X direction in FIG. 11), the sustain electrode electrode terminals 56 are provided to the other short side of the PDP 30, and data electrode electrode terminals are provided to both long sides of the PDP 30 (note that the scan electrode electrode terminals 52, the sustain electrode electrode terminals 56, and the data electrode electrode terminals are undepicted in FIG. 11).

Further, the flexible circuit boards 10, the flexible circuit boards 58, and the flexible circuit boards 59 are electrically connected with the scan electrode electrode terminals 52, the sustain electrode electrode terminals 56, and the data electrode electrode terminals, respectively.

The heat conduction sheets 82 are provided as a means for adhering the chassis 81 to the PDP 30. At the same time, the heat conduction sheets 82 also have the function of radiating and discharging heat generated by the PDP 30 by conducting the heat to the chassis 81. In addition, while one surface of the chassis 81 holds the PDP 30 via the heat conduction sheets 82, the other surface of the chassis 81 holds the circuit boards composing the circuit board group 83.

In FIG. 11, among the circuit boards composing the circuit board group 83, the circuit board 71, which has the sustain pulse generating unit and the initializing waveform generating unit of the scan electrode driving circuit 63 mounted thereon, and the circuit boards 72 and 73, each of which having a portion of the scan pulse generating unit 69 of the scan electrode driving circuit 63 mounted thereon, are explicitly illustrated. Further, each of the circuit boards 72 and 73 is provided with a plurality of connectors 76 and a plurality of connectors 77. The connectors 76 and 77 are for outputting a driving voltage waveform to each of the scan electrodes 32. More specifically, in embodiment 5, the connectors 76, which are to be connected with the circuit connection portions 12 of the flexible circuit boards 10, are provided to one surface (rear surface) of each of the circuit boards 72 and 73. On the other hand, the connectors 77, which are to be connected to the circuit connection portions 13 of the flexible circuit boards 10, are provided to the other surface (front surface) of each of the circuit boards 72 and 73.

The flexible circuit boards 10, which are connected with the scan electrode electrode terminals 52 of the PDP 30, are also connected with the connectors 76 and 77 (indicated by the dashed double-dotted arrow in FIG. 11) by spanning over the chassis 81. More specifically, the circuit connection portions 12 of the flexible circuit boards 10 are connected to the connectors 12, whereas the circuit connection portions 13 of the flexible circuit boards 10 are connected to the connectors 77.

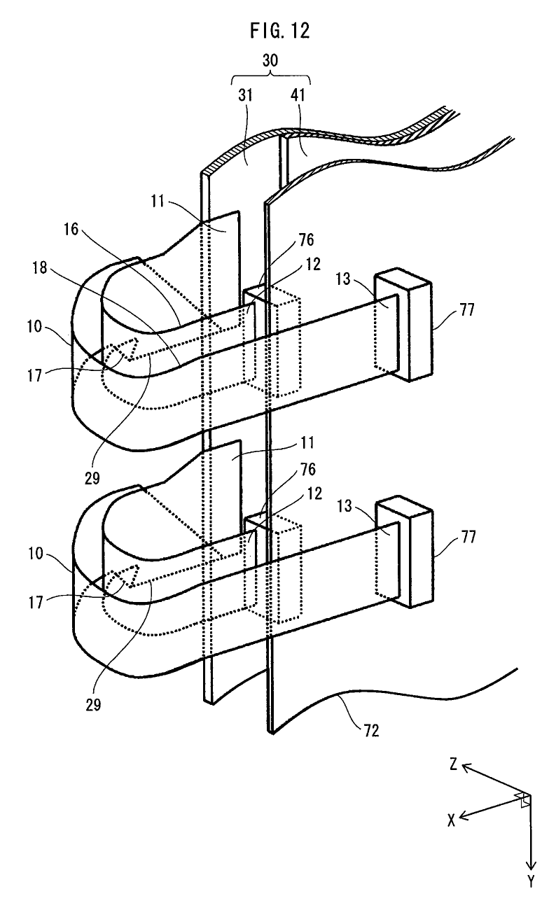

FIG. 12 is an enlarged view illustrating how the flexible circuit boards 10 provide connection in the plasma display apparatus 60 in embodiment 5 of the present invention.

In the structure illustrated in FIG. 12, the connectors 76 are disposed to one main surface of the circuit board 72, and the connectors 77 are disposed to the other main surface of the circuit board 72. The connectors 76 and the connectors 77 are disposed to the circuit board 72 for connection with the flexible circuit boards 10.

The panel connection portions 11 of the flexible circuit boards 10 are connected with the scan electrode electrode terminals 52 (undepicted) provided to one short side of the front substrate 31 of the PDP 30. More specifically, the flexible circuit boards 10 are connected with the scan electrode electrode terminals 52 by, for instance, placing a flexible circuit board 10 and corresponding scan electrode electrode terminals 52 one on top of the other with an anisotropic conductive film sandwiched therebetween and by applying heat and pressure thereto.

The flexible circuit boards 10 are folded along the fold portions 29 such that the second circuit parts 18 overlap the first circuit parts 16. Each of the flexible circuit boards 10 is folded towards the circuit board 72 so as to span over the chassis 81 (undepicted). Further, the circuit connection portions 12 of the flexible circuit boards 10 are connected to the connectors 76 provided to the rear surface of the circuit board 72, and the circuit connection portions 13 of the flexible circuit boards 10 are connected to the connectors 77 provided to the front surface of the circuit board 72.

Although illustration of the chassis 81 is omitted in FIG. 12 for the mere sake of facilitating understanding, it is to be noted that the chassis 81 actually exists between the PDP 30 and the circuit board 72 as illustrated in FIG. 11.

As explanation has been provided with reference to FIG. 8, there is a need of applying a different driving voltage waveform to each of the scan electrodes 32 of the PDP 30. Further, a considerable difference in voltage of 50 V-100 V is applied to different ones of the scan electrodes 32 during the writing period. In addition, there is a need of causing a high current to flow through the scan electrodes 32 during the sustain period. As such, the pitch between the circuit connection terminals 22 and the pitch between the circuit connection terminals 23 cannot be reduced limitlessly. On the other hand, when implementing the PDP 30 by utilizing a high definition panel, the intervals between the scan electrode electrode terminals 52 are reduced in accordance with the intervals between the scan electrodes 32. Hence, the pitch between the circuit connection terminals 22 and the pitch between the circuit connection terminals 23 need to be set so as to be respectively greater than the pitch between the panel connection terminals 21a and the pitch between the panel connection terminals 21b, which are provided at the panel connection portion 11.

However, even when the pitch between the panel connection terminals 21a and the pitch between the panel connection terminals 21b respectively differ from the pitch between the circuit connection terminals 22 and the circuit connection terminals 23, this difference in pitch can be overcome by changing the pitch between the connection terminals on the flexible circuit board 10 in an appropriate manner (refer to FIG. 1).

In addition, when actually implementing the flexible circuit board 10, the width occupied by the flexible circuit board 10 can be suppressed so as to be similar to the width of the panel connection portion 11 by lightly folding the flexible circuit board 10 along the fold portion 29 and by connecting the flexible circuit board 10 with the connector 76 and the connector 77 respectively provided to the rear surface and the front surface of the circuit board 72. Accordingly, even when a plurality of the flexible circuit boards 10 are connected with a PDP 30 that is a high definition panel in the image display apparatus, the image display apparatus can be provided with spatial efficiency. This is made possible by disposing each of the connectors 76 and the connectors 77 in a line on the corresponding surface of the circuit board 72, and by connecting the flexible circuit boards 10 to the connectors 76 and the connectors 77 such that adjacent ones of the flexible circuit boards 10 are within a certain degree of closeness with respect to each other.

Note that in the plasma display apparatus 60 pertaining to embodiment 5, explanation has been provided taking the flexible circuit board 10, in which the distance between the panel connection portion 11 and the circuit connection portion 13 is greater than the distance between the panel connection portion 11 and the circuit connection portion 12, as an example. The flexible circuit board 10 having such a structure is desirable since (i) the circuit connection portion 12 and the connector 76 can be connected efficiently by disposing the connector 76 at the rear surface of the circuit board 72 at an area comparatively close to an edge portion of the circuit board 72 and (ii) the circuit connection portion 13 and the connector 77 can be connected efficiently by disposing the connector 77 at the front surface of the circuit board 72 at an area comparatively distant from an edge portion of the circuit board 72.

However, the present invention is not limited to this. For instance, the connector 76 can be provided at the rear surface of the circuit board 72 at an area comparatively distant from the edge portion of the circuit board 72, and the connector 77 can be provided at the front surface of the circuit board 72 at an area comparatively close to the edge portion of the circuit board 72. In addition, the distance between the area at which the connector 76 is disposed and the corresponding edge portion of the circuit board 72 may be set to be substantially equal to the distance between the area at which the connector 77 is disposed and the corresponding edge portion of the circuit board 72. Alternatively, a plurality of connectors 76 to be connected with the circuit connection portions 12 of the flexible circuit boards 10 may be provided at the front surface of the circuit boards 72 and 73, and further, a plurality of connectors 77 to be connected with the circuit connection portions 13 of the flexible circuit boards 10 may be provided at the rear surface of the circuit boards 72 and 73. As such, the areas of the circuit boards at which the connectors 76 and the connectors 77 are to be provided are to be set according to factors such as (i) the arrangement of the panel connection portion 11, the circuit connection portion 12 and the circuit connection portion 13 on the flexible circuit board 10, and (ii) the arrangement of the wires 25 on the surface of the base material (resin film) of the flexible circuit board 10.

(Other Matters)

In embodiment 5, explanation is provided taking as an example an image display apparatus in which the flexible circuit boards 10 in embodiment 1 are connected with the PDP 30 and the driving circuit boards 71-73. However, the image display apparatus pertaining to the present invention is not limited to having such a structure, and the image display apparatus pertaining to the present invention may be implemented by connecting any one of the flexible circuit boards in embodiments 2-4 with the PDP 30 and the driving circuit boards 71-73.

Further, note that the specific values indicated in embodiments 1-5 are merely provided as examples of such values, and the present invention is not limited to such values. It is desirable that such values be set as appropriate according to the characteristics of the image display device to be utilized, the specification of the image display apparatus, etc.

In addition, in embodiments 1 and 5 above, explanation is provided of example structures where the circuit connection portion 12 and the circuit connection portion 13 of the flexible circuit board 10 are mainly connected with the circuit board 72 and the circuit board 73. However, the present invention is not limited to this, and the circuit connection portions of the flexible circuit board 10 may be connected to other circuit boards which may be disposed in the image display apparatus.

In embodiment 5 above, explanation is provided taking a PDP as an example of the image display device. However, the present invention is not limited to this, and the PDP may be replaced by other image display devices such as an LCD and an organic EL display panel (OELD).

### INDUSTRIAL APPLICABILITY

The present invention provides an image display apparatus having superior quality by realizing excellent connection between an image display device and a circuit board such as a driving circuit. Examples of the image display devices include: a high definition PDP, other PDPs having conventional specifications, FPDs such LCDs and OELDs, and CRTs. As such, the present invention has an extremely wide range of industrial applicability, and therefore, has high usability.

### REFERENCE SIGNS LIST

10, 10A, 10B, 10C flexible circuit board
11 panel (device) connection portion
12, 13 circuit connection portion
15, 15A, 15B, 15C circuit portion
16, 16A, 18A first circuit part
17, 17X, 17A, 17B separating part
18, 18X, 18B second circuit part
18C third circuit part
19 common circuit part
21a, 21b panel (device) connection terminals
22, 23, 24 circuit connection terminals
25a, 25b, 25c wires
29, 29A, 29B fold portion
30 PDP (image display device)
31 front panel glass
32 scan electrodes
33 sustain electrodes
34 display electrode pairs
35, 43 dielectric layer
36 protective layer
37 front substrate (front panel)
41 back panel glass
42 data (address) electrodes
44 banks
45 phosphor layer
46 discharge space
47 back substrate (back panel)
51 lead wire
52 scan electrode electrode terminal
53, 57 electrode terminal group
55 short circuit wire
56 sustain electrode electrode terminal
58, 59 flexible circuit board
60 plasma display apparatus
61 image signal processing circuit
62 data electrode driving circuit
63 scan electrode driving circuit
64 sustain electrode driving circuit
65 timing generation circuit
69 scan pulse generation unit
71, 72, 73, 90 circuit board
76, 77, 92, 93 connector
81 chassis
82 heat conduction sheet
83 circuit board group
84 front frame
85 back cover

1. An image display apparatus comprising an image display device, a circuit board, and a flexible circuit board electrically connecting the image display device and the circuit board, wherein
the flexible circuit board is constituted of a plurality of parts including a common circuit part, a first circuit part, and a second circuit part, the first circuit part and the second circuit part extending from one side of the common circuit part separately from each other,
the flexible circuit board includes:
a plurality of wires, the wires constituted of a first wire extending from the first circuit part to the common circuit part and a second wire extending from the second circuit part to the common circuit part, the first wire and the second wire meeting at the common circuit part so as to form a side-by-side arrangement at the common circuit part when the flexible circuit board is viewed in plan view;
a plurality of device connection terminals for connecting the flexible circuit board with the image display device, the device connection terminals disposed at the common circuit part; and
a plurality of circuit connection terminals for connecting the flexible circuit board with the circuit board, the circuit connection terminals constituted of a first circuit connection terminal and a second circuit connection terminal respectively disposed at the first circuit part and the second circuit part,
in the flexible circuit board, the device connection terminals are electrically connected one-to-one with the circuit connection terminals via the wires,
the circuit board includes a first connector disposed at one surface thereof and a second connector disposed at the other surface thereof, and
the flexible circuit board is electrically connected with the circuit board by the first circuit connection terminal being connected with the first connector and the second circuit connection terminal being connected with the second connector while the flexible circuit board is folded at at least one of a position within the first circuit part and a position within the second circuit part.

2. The image display apparatus of claim 1, wherein
a pitch between the circuit connection terminals is greater than a pitch between the device connection terminals.

3. The image display apparatus of claim 2, wherein
at least one of the first connector and the second connector is provided in plurality and is arranged in line on the corresponding surface of the circuit board.

4. The image display apparatus of claim 1, wherein
the first circuit part has an elongated shape,
the second circuit part is constituted of a separating portion that protrudes from the common circuit part and an elongated portion that extends from the separating portion parallely to the first circuit part in a longitudinal direction of the first circuit part, and
the first circuit connection terminal is disposed at an end of the first circuit part in the longitudinal direction of the first circuit part, and the second circuit connection terminal is disposed at an end of the elongated portion of the second circuit part in a longitudinal direction of the second circuit part.

5. The image display apparatus of claim 1, wherein
the first circuit part and the second circuit part have elongated shapes,
a length of the second circuit part in a longitudinal direction of the second circuit part is shorter than a length of the first circuit part in a longitudinal direction of the first circuit part, and
the first wire and the second wire have the same length.

6. The image display apparatus of claim 1, wherein
the first circuit part and the second circuit part have elongated shapes,
a length of the second circuit part in a longitudinal direction of the second circuit part is longer than a length of the first circuit part in a longitudinal direction of the first circuit part, and
the second wire is longer than the first wire.

7. The image display apparatus of claim 1, wherein
the plurality of parts constituting the flexible circuit board further includes a third circuit part extending from the one side of the common circuit part separately from the first circuit part and the second circuit part,
the first circuit part, the second circuit part, and the third circuit part have elongated shapes, and
(i) a length of the first circuit part in a longitudinal direction of the first circuit part, (ii) a length of the second circuit part in a longitudinal direction of the second circuit part, and (iii) a length of the third circuit part in a longitudinal direction of the third circuit part differ from each other.

8. The image display apparatus of claim 1, wherein
the wires are each coated with two layers of resin film.

9. The image display apparatus of claim 1, wherein
the image display device is a plasma display device including a front panel and a back panel that are disposed facing each other with a discharge space therebetween, the discharge space enclosing discharge gas,
the front panel includes a front panel glass, a plurality of display electrode pairs disposed in a side-by-side arrangement on a surface of the front glass panel, and a dielectric layer covering the display electrode pairs, the display electrode pairs each composed of a scan electrode and a sustain electrode, and
the back panel includes a back panel glass, a plurality of data electrodes disposed in a side-by-side arrangement on a surface of the back panel glass facing the surface of the front panel glass, and a dielectric layer covering the data electrodes, the data electrodes disposed so as to cross the display electrode pairs at right angles, and
each of the device connection terminals is electrically connected with a corresponding one of the scan electrodes.
